(19) United States
(12) Patent Application Publication
(10) Pub. No.: US 2025/0242964 A1
(43) Pub. Date: Jul. 31, 2025

(54) A MEMBER FOR SUPPORTING ONE OR MORE ARTICLES

(71) Applicant: RENOGROUP S.R.L., Bologna (IT)

(72) Inventors: Sergio MEZZINI, Bologna (IT); Federico BACCOLINI, Bologna (IT)

(21) Appl. No.: 18/844,477

(22) PCT Filed: Mar. 7, 2023
(86) PCT No.: PCT/IB2023/052145

§ 371 Date: Sep. 6, 2024

(30) Foreign Application Priority Data
Mar. 9, 2022 (IT) 102022000004499

(51) Int. Cl. B65D 5/50; A61J 1/16; B65D 5/42

(52) U.S. Cl. CPC B65D 5/504; A61J 1/16; B65D 5/4266

(57) ABSTRACT

A member for supporting, including ampules and vials, said support member adapted to be part of a corresponding package, including a corresponding outer holding device housing the support member, and formed as a corresponding box-shaped body, in in corresponding paper material, within which the support member, together with the articles supported thereby, is inserted. The support member includes a device for engaging and retaining the articles, and a further device for supporting the device. The device being in corresponding foldable material, preferably in paper material, such as cardboard or paperboard, and including at least one corresponding folding, or creasing, line. A device adapted to eliminate, or reduce, the elastic return reaction of the respective folding, or creasing, line, which is provided in the device is provided for.

### APPLICATION FIELD OF THE PRESENT INVENTION

The present invention relates to a member for supporting one or more articles.

### STATE OF THE ART

Members or bodies for supporting ampoules and vials containing a product of the pharmaceutical, cosmetic and/or food type, which are adapted to be part of a corresponding box-shaped package, in corresponding paper material, preferentially in cardboard or paperboard, are known.

The already-known support members generally comprise engaging and retaining means for said ampoules and vials, and means for supporting said engaging and retaining means, and exhibit said engaging and retaining means that are in corresponding foldable material, preferably in paper material, such as cardboard or paperboard, and are such as to comprise at least one corresponding folding, or creasing, line.

One problem felt in relation to these already-known supporting members, or bodies, relates to the deformation or bending of the support member of said articles, which severely hinders the handling in the corresponding packaging machines, and in particular the insertion of the same support members into the corresponding holding, especially box-shaped, body of the package.

A further drawback that is felt in connection with said deformation or bending of the support member of said articles is that the same support member is of a completely unsightly workmanship, hence unpleasant to the consumers of the respective articles.

### SUMMARY OF THE INVENTION

Therefore, with the present invention it is desired to propose a new, alternative solution to the solutions known so far, and in particular it is proposed to obviate one or more of the drawbacks or problems referred to above and/or to meet one or more of the needs referred to above, and/or however felt in the art, and in particular deducible from the above.

Thus, a member is provided for supporting one or more articles, especially in the form of ampoules, vials or other, in particular in glass or plastic, preferably containing a product of the pharmaceutical, cosmetic and/or food type; preferentially said support member is adapted to be part of a corresponding package, especially comprising corresponding outer holding means which house, and, in particular, surround, or wrap, the same support member, and which are preferably in the form of a corresponding box-shaped body, in particular in corresponding paper material, preferentially in cardboard or paperboard, within which said support member, in particular together with said one or more articles supported thereby, is inserted; said support member comprising means for engaging and retaining said one or more articles, and means for supporting said means for engaging and retaining said one or more articles, said means for engaging and retaining said one or more articles being in corresponding foldable material, preferably in paper material, such as cardboard or paperboard, and comprising at least one corresponding folding, or creasing, line; characterized in that means adapted to eliminate, or reduce, the elastic return reaction of the respective folding, or creasing, line, which is provided in said means for engaging and retaining said one or more articles are provided for.

In this manner, it is possible to limit, or eliminate, the deformation or bending of the support member of said articles, such as it can hinder the handling thereof in the corresponding packaging machines and in particular the insertion thereof in the corresponding holding, especially box-shaped, body.

### BRIEF DESCRIPTION OF THE DRAWINGS

This and other novel aspects, or respective advantageous embodiments, are however set forth in the attached claims, the specific technical characteristics of which can be found, together with corresponding advantages obtained, in the following description, illustrating in detail merely exemplary, non-limiting embodiments of the invention, and which is made with reference to the attached drawings, in which:

FIG. 1A illustrates a schematic, perspective view of a first preferred embodiment of support member of corresponding articles according to the present invention;

FIG. 1B illustrates a schematic, perspective view of the first preferred embodiment of support member of corresponding articles according to the present invention, taken at a different side than the one of FIG. 1A;

FIG. 1C illustrates a schematic, perspective view of the first preferred embodiment of support member of corresponding articles according to the present invention, without the articles to be supported;

FIG. 1D illustrates a schematic, perspective view of the first preferred embodiment of support member of corresponding articles according to the present invention, without the articles to be supported and taken at a different side than the one of FIG. 1C;

FIG. 1E illustrates a schematic, perspective view of the first preferred embodiment of support member of corresponding articles according to the present invention, without the articles to be supported and taken fully on its side;

FIG. 1F illustrates a schematic, perspective bottom view of the first preferred embodiment of support member of corresponding articles according to the present invention, without the articles to be supported;

FIG. 1G illustrates a schematic, perspective view of an enlarged detail of the first preferred embodiment of support member of corresponding articles according to the present invention, without the articles to be supported;

FIG. 1H illustrates a schematic, perspective bottom view of an enlarged detail of the first preferred embodiment of support member of corresponding articles according to the present invention, without the articles to be supported;

FIG. 2 illustrates a schematic, perspective view of the first preferred embodiment of member according to the present invention in a stacked condition;

FIG. 3A illustrates a schematic, perspective view of a preferred embodiment of a blank sheet adapted to define means for engaging and retaining said one or more articles of the first preferred embodiment of member according to the present invention;

FIG. 3B illustrates a schematic, perspective view of a preferred embodiment of a blank sheet adapted to define means for supporting said means for engaging and retaining said one or more articles of the first preferred embodiment of member according to the present invention;

FIG. 4A illustrates a schematic, sectional view of a detail of the blank sheet adapted to define means for engaging and retaining said one or more articles of the first preferred embodiment of member according to the present invention, at a folding zone, with the sheet in a deployed, not yet folded, condition;

FIG. 4B illustrates a schematic, sectional view of a detail of the blank sheet adapted to define means for engaging and retaining said one or more articles of the first preferred embodiment of member according to the present invention, at a folding zone, with the sheet in a folded condition;

FIG. 5 illustrates a schematic, perspective view of a second preferred embodiment of support member according to the present invention;

FIG. 6A illustrates a schematic plan view of the lower face of the blank sheet adapted to define means for engaging and retaining said one or more articles of the second preferred embodiment of member according to the present invention;

FIG. 6B illustrates a schematic plan view of the upper face of the blank sheet adapted to define means for engaging and retaining said one or more articles of the second preferred embodiment of member according to the present invention;

FIG. 7 illustrates a schematic, perspective view of a third preferred embodiment of support member according to the present invention.

### DETAILED DESCRIPTION OF PREFERRED EMBODIMENTS OF THE INVENTION

In the attached Figures, a first 10, a second 100, and a third 200 preferred embodiments of member 100 for supporting one or more articles 11, 11′, especially in the form of ampoules, vials or other, in particular in glass or plastic, preferably containing a product of the pharmaceutical, cosmetic and/or food type, preferably in a liquid condition or like are illustrated, and especially, as illustrated, having a suitably shaped outer profile.

Preferentially the support member 10, 100 is adapted to be part of a corresponding package, especially comprising corresponding outer holding means which house, and in particular surround, or wrap, the same support member 10, 100, and which are preferably in the form of a corresponding box-shaped body, not particularly illustrated in the attached figures, in particular in corresponding paper material, preferentially in cardboard or paperboard, within which said support member 10, 100, in particular together with said one or more articles 11 supported thereby, is inserted.

Appreciably, as illustrated, the support member 10, 100 comprises means 12 for engaging and retaining said one or more articles 11, and means 14 for supporting said means 12 for engaging and retaining said one or more articles 11, in particular in paper material, such as cardboard or paperboard.

In particular, said means 12 for engaging and retaining said one or more articles 11 are, in particular at least in part, in corresponding foldable material, preferably in paper material, such as cardboard or paperboard, and comprise at least one corresponding folding, or creasing, line, 18, 18′, in particular provided in said foldable or paper material.

In an appreciably advantageous manner, as illustrated, means 20, 20′ are provided, which are adapted to eliminate, or reduce, the elastic return reaction of the respective folding, or creasing, line, 18, 18′, which is provided in said means 12 for engaging and retaining said one or more articles 11.

In this manner, it is possible to limit, or completely avoid, the deformation or bending of the support member of said articles 11, such that it can hinder the handling thereof in the corresponding packaging machines, and in particular the insertion thereof into the corresponding, especially box-shaped, holding body, moreover enabling the same support member 10 to be made with a workmanship that is valuable from an aesthetical viewpoint.

As can be seen from said figures, advantageously, said means 20, 20′ which are adapted to eliminate, or reduce, the elastic return reaction of the respective are provided at, in particular within, the same folding, or creasing, line, 18, 18′.

As can be seen from said figures, advantageously, said means adapted to eliminate, or reduce, the elastic return reaction of the respective folding, or creasing, line, 18, 18′ comprise, or are in the form of corresponding means 20, 20′ for weakening the folding, or creasing, line, 18, 18′.

As can be seen from said figures, advantageously, said means adapted to eliminate, or reduce, the elastic return reaction of the respective folding, or creasing, line, 18, 18′ are in the form of corresponding means 20, 20′ for interrupting the integrity of said folding, or creasing, line, 18, 18′, in particular extending internally to said folding, or creasing, line, 18, 18′.

With advantage, as can be seen in particular from the figures, said means 20 for interrupting the continuity 20 of said folding, or creasing, line, 18 extend within the same folding, or creasing, line, 18, only to part of the thickness of the respective folding, or creasing, line, 18, as in any case can be best seen from the following of the present description.

With advantage, as can be seen from the figures, said means 20 for interrupting the integrity of said folding, or creasing, line, 18 comprise, or are composed of, a corresponding cut which extends at, i.e., within, the same folding, or creasing, line, 18, by a corresponding part of the thickness thereof.

With advantage, as can be seen from the figures, in particular said means 20 for interrupting the continuity 20 of said folding, or creasing, line, 18 extend within the same folding, or creasing, line, 18, by a length that is substantially equal to half the thickness of the respective folding, or creasing, line, 18, i.e., the thickness of the corresponding blank sheet.

With advantage, as can be seen from the figures, said means adapted to eliminate, or reduce, the elastic return reaction of the respective folding, or creasing, line, 18′, i.e., said means for weakening said folding, or creasing, line, 18′, are in the form of means 20′ adapted to reduce the extension, in particular the longitudinal extension, of the same folding, or creasing, line, 18′.

As can be seen from said figures, advantageously, preferably, said means 20′ for interrupting the continuity 20′ of said folding, or creasing, line, 18′ extend passing through the same corresponding folding, or creasing, line, 18′, as in any case can be best seen from the following of the present description.

As can be seen from said figures, advantageously, said means adapted to reduce the extension, in particular the longitudinal extension, of the same folding, or creasing, line, 18′ are in the form of corresponding means 20′ for interrupting the continuity 20′ of said folding, or creasing, line, 18′, in particular provided internally to, or far from the ends of, said folding, or creasing, line, 18′.

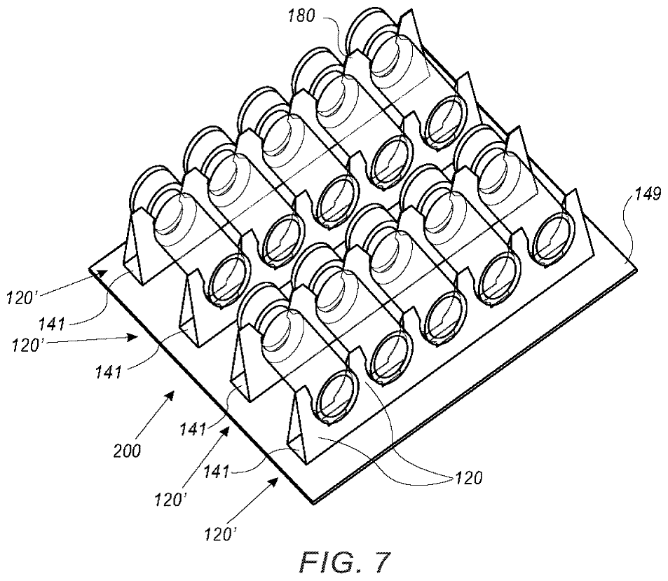

As can be seen from said figures, advantageously, said means adapted to eliminate, or reduce, the elastic return reaction of the respective folding, or creasing, line, 18, 18′, i.e., said means for weakening said folding, or creasing, line, 18, 18′, comprise at least one corresponding cut 20, 20′, which is preferably longitudinally provided in the corresponding folding, or creasing, line, 18, 18′, as is best seen in particular from FIG. 7A.

As can be seen from said figures, advantageously, said means 20 adapted to eliminate, or reduce, the elastic return reaction of the respective folding, or creasing, line, 18, i.e., said means for weakening said folding, or creasing, line, 18, extend across the entire length of the respective said folding, or creasing, line, 18.

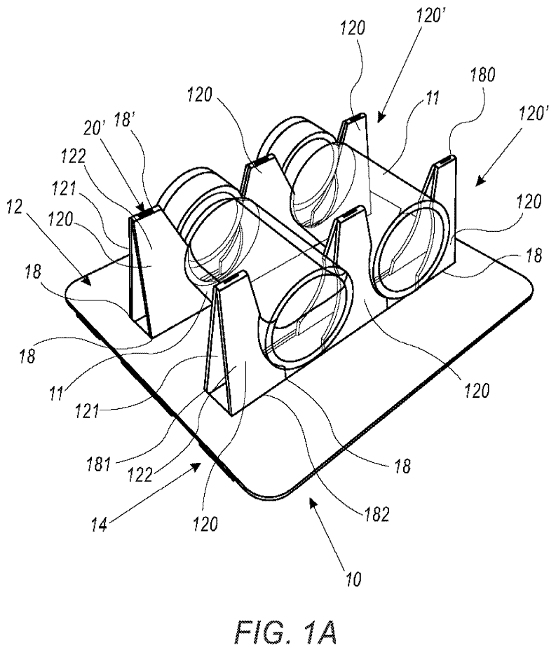

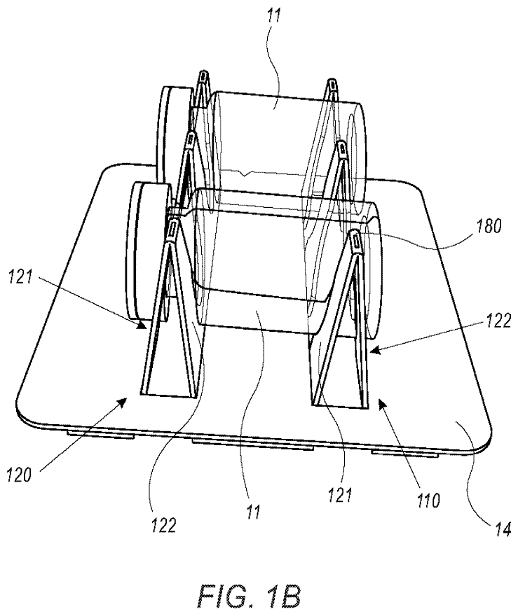

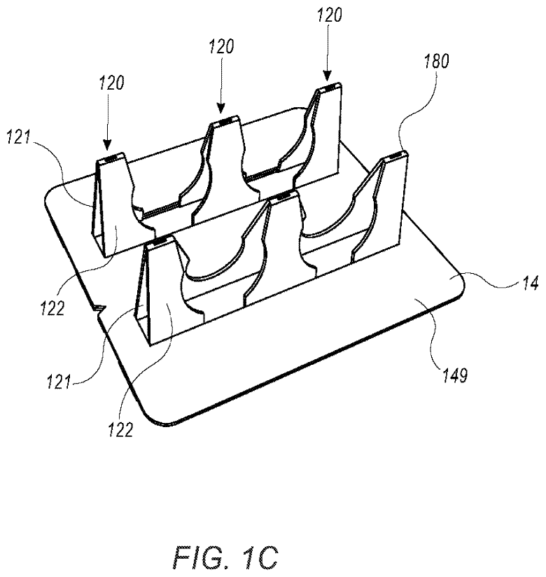

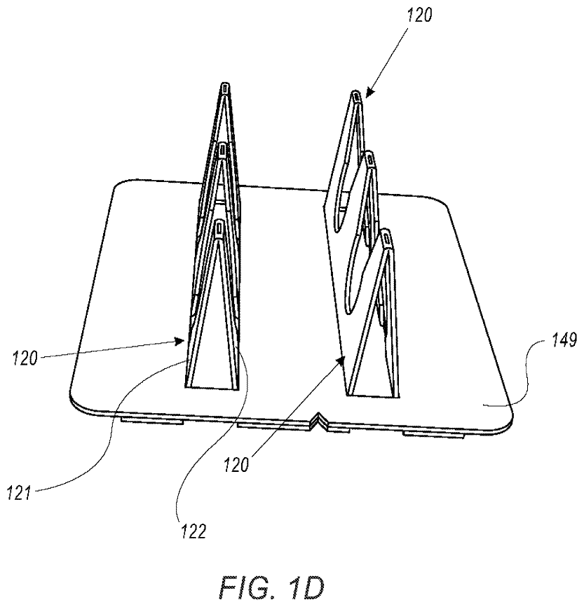

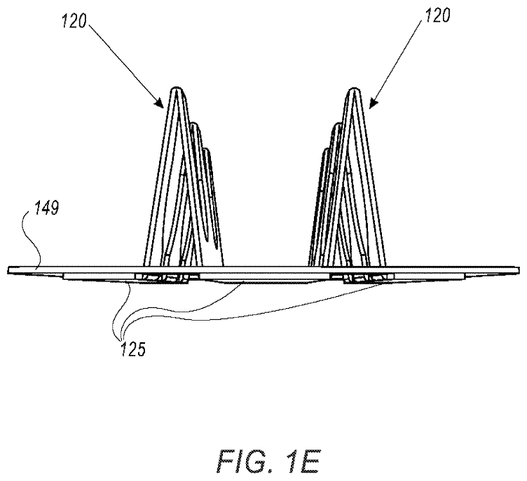

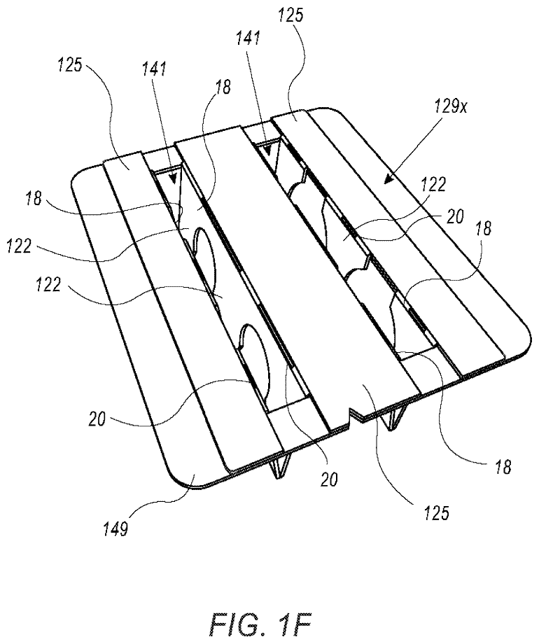

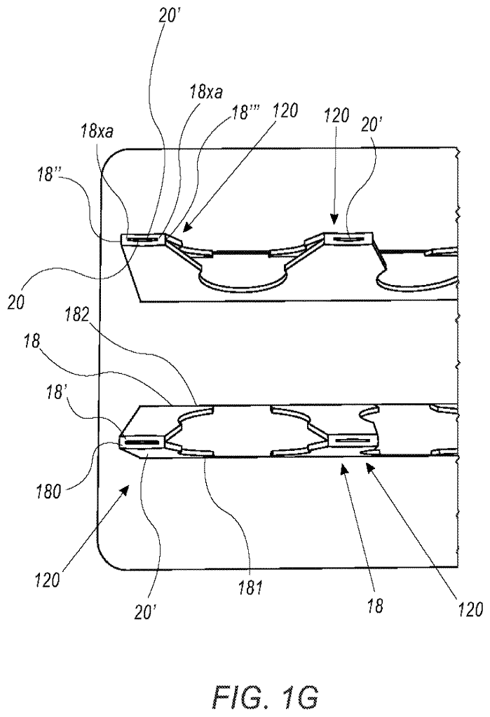

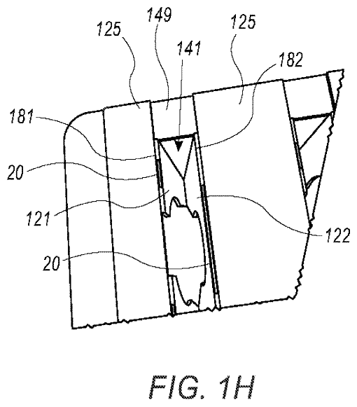

As can be seen from said figures, advantageously, said means adapted to eliminate, or reduce, the elastic return reaction of the respective folding, or creasing, line, 18, 18′, i.e., said means for weakening said folding, or creasing, line, 18′, extend centrally in the corresponding folding, or creasing, line, 18′, i.e., spaced apart from the outermost edges 18″, 18″′ of the same folding, or creasing, line, 18′, with said folding, or creasing, line, 18′ exhibiting, as can be seen in particular from FIG. 1G, at least one first and a second continuous, i.e., non-interrupted outermost parts, 18xa, 18xa.

In an advantageous manner, as can be seen from said figures, said means adapted to eliminate, or reduce, the elastic return reaction of the respective folding, or creasing, line, 18′, i.e., said means for weakening said folding, or creasing, line, 18′, comprise a single, preferentially through, cut 20′, provided in said folding, or creasing, line, 18′, and which preferably extends longitudinally, in particular centrally, in the corresponding folding, or creasing, line, 18′.

As can be seen from said figures, advantageously, said means adapted to eliminate, or reduce, the elastic return reaction of the respective folding, or creasing, line, 18′, in particular said means for weakening said folding, or creasing, line, 18′, i.e., the respective cut, extend, or extends, by a length that is less than half, or substantially half, the length of the corresponding folding, or creasing, line, 18′.

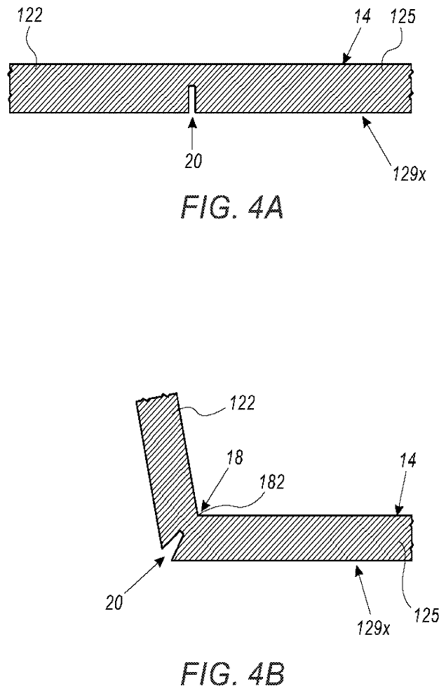

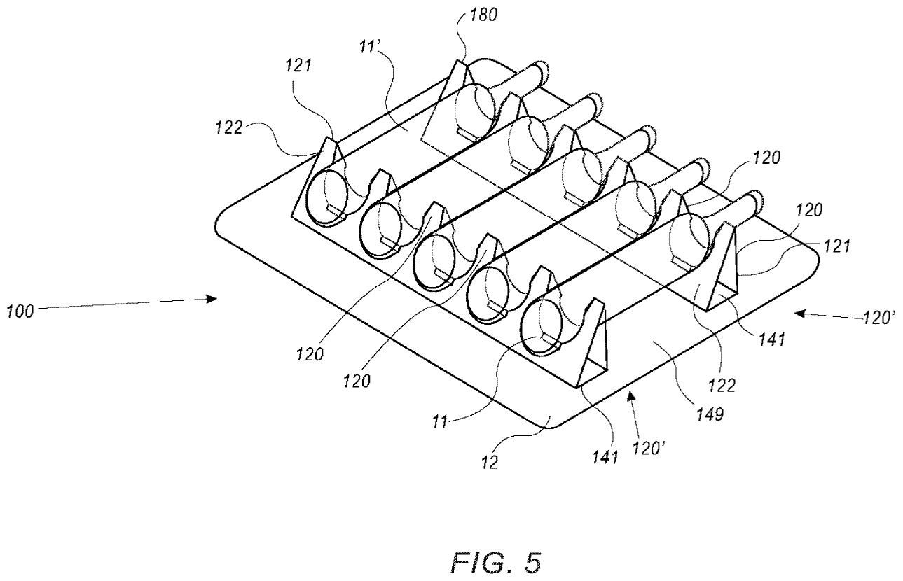

As can be seen from said figures and in particular from FIG. 4B, advantageously, said means adapted to eliminate, or reduce, the elastic return reaction of the respective folding, or creasing, line, 18, i.e., the respective cut 20, extend, or extends, starting from the extrados face 129x of the respective folding, or creasing, line, 18, i.e., from the lower face of the respective blank sheet.

As can be seen from said figures, advantageously, said means 12 for engaging and retaining said one or more articles 11 comprise at least one first and a second grasping portions 120, 120 projecting from said means 14 for supporting the same engaging and retaining means 12, which are adapted to grasp, in particular by engaging it on opposite sides, a corresponding part of a respective article 11.

In a particularly advantageous manner, as can be seen from said figures, said means 12 for engaging and retaining said one or more articles 11 comprise a plurality of, in particular a first and a second, as illustrated in the FIGS. 1A, 1B, in relation to a first 10 and a second 100 preferred embodiments of support member, series 120′ of grasping portions 120, in particular adapted to grasp corresponding, preferably outermost, parts, of corresponding articles 11, i.e., a first, second, third, fourth series 120′ of grasping portions 120, in particular adapted to grasp corresponding, preferably outermost, parts, of corresponding articles 11, as illustrated in the third preferred embodiment 200 of FIG. 7.

Especially, as illustrated, the respective series 120′ comprises two or more grasping portions 120, which are adapted to grasp corresponding, preferably outermost, parts, of one or more corresponding articles 11.

As can be seen from said figures, in said preferred embodiments, advantageously, the respective grasping portion 120 for engaging and retaining the respective article 11 comprises a respective first and second flaps 121, 122 projecting from said means 14 for supporting said means 12 for engaging and retaining said one or more articles 11, which said first and second flaps 121, 122 are preferably facing one another, and in particular spaced apart from one another, especially according to a transversal direction of said support member 10.

As can be seen from said figures, advantageously, said first and second flaps 121, 122 defining the respective grasping portion 120 are, in extension from said means 14 for supporting said engaging and retaining means 12, convergent to one another, and preferably having a planar-like configuration.

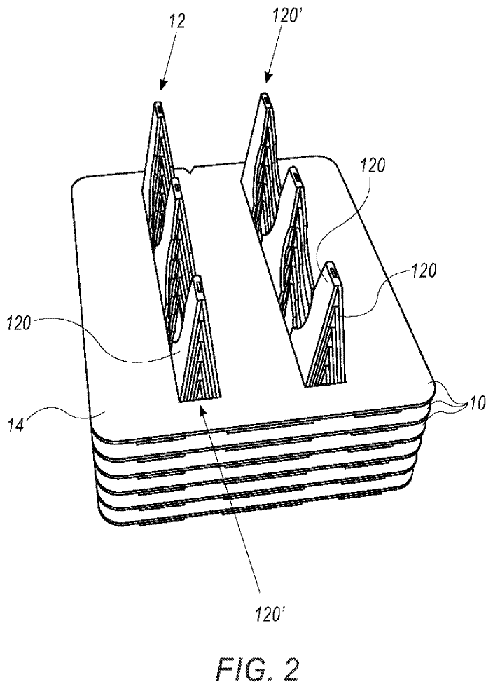

In this manner, it is possible to make, as is well illustrated in FIG. 2, said support members 10 stackable.

In an appreciably advantageous manner, as can be seen from said figures, said first and second flaps 121, 122 defining the respective grasping portion 120 are each connected to said means 14 for supporting said means 12 for engaging and retaining said one or more articles 11 through a respective and corresponding folding, or creasing, line, 181, 182.

As can be seen from said figures, advantageously, said first and second flaps 121, 122 defining the respective grasping portion 120 are converging to one another up to a common outermost folding, or creasing, line, 180.

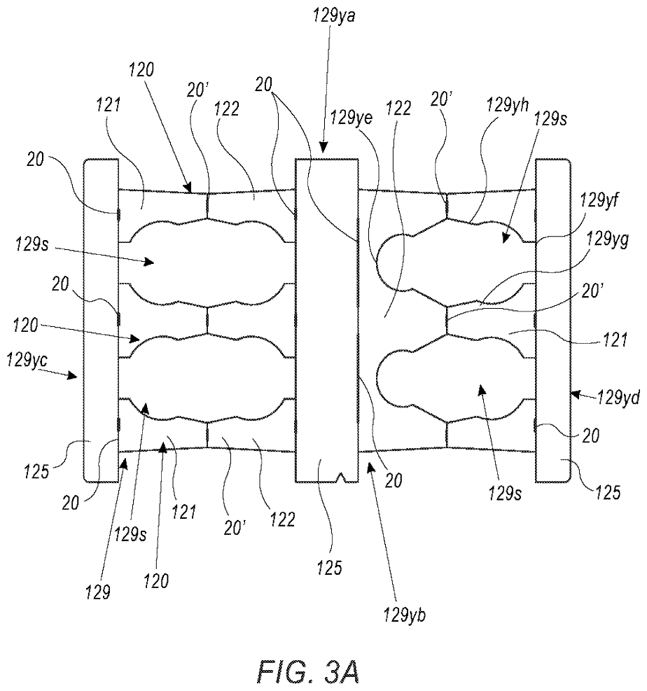

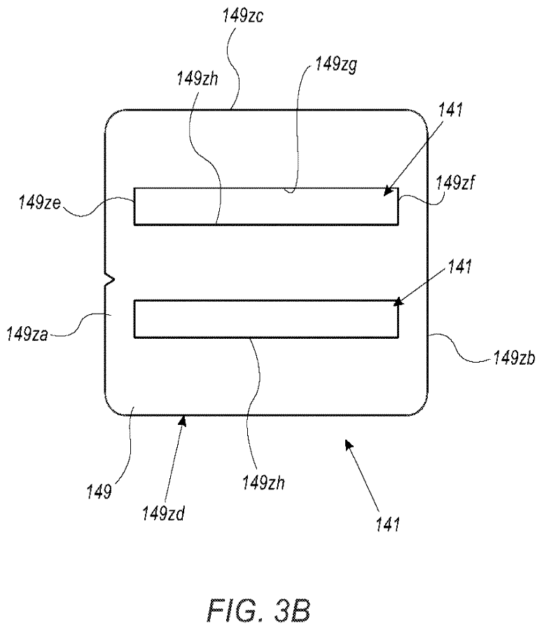

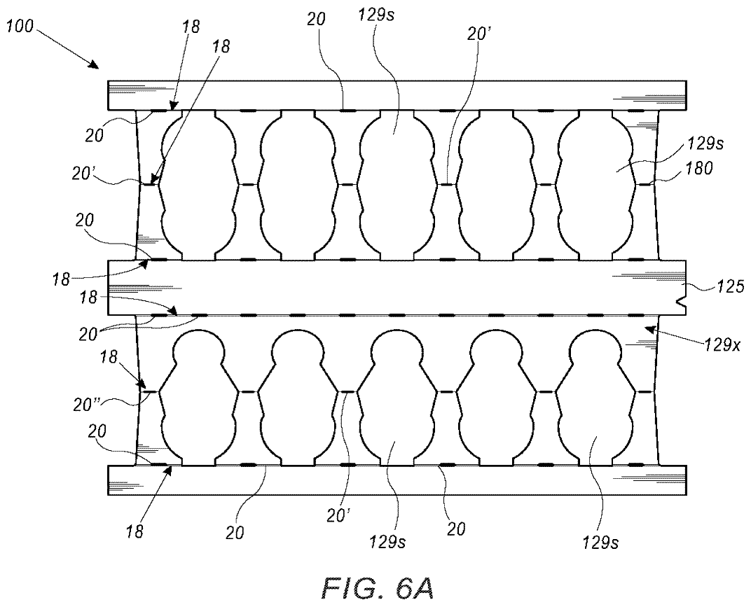

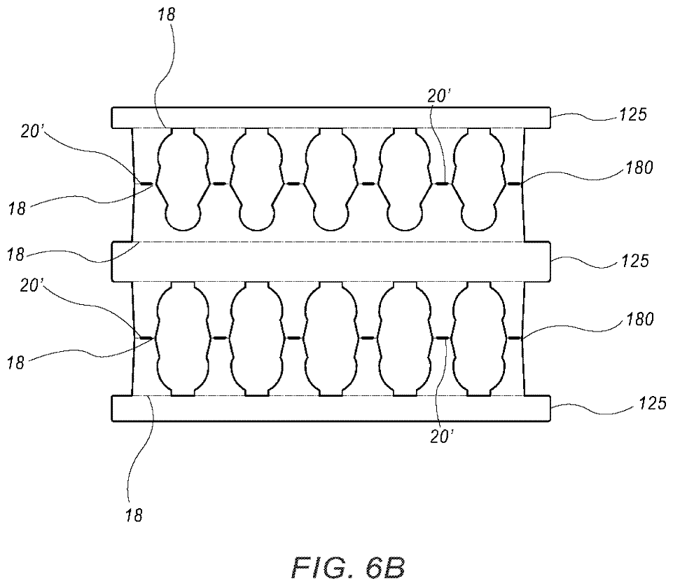

As can be seen in particular from said FIGS. 3A, 6A, and 6B, advantageously, said means 12 for engaging and retaining said one or more articles 11, i.e., said grasping portions 120, in particular the respective first and second flaps 121, 122 defining the respective grasping portion 120, extend from a corresponding base portion 125, in particular defining part of said means 14 for supporting said means 12 for engaging and retaining said one or more articles 11.

With appreciable advantage, as can be seen from said figures, a plurality of said base portions 125 are provided, preferably mutually parallel and from which the respective first and second flaps 121, 122 defining the respective grasping portion 120 extend.

As can be seen from said figures, advantageously, said base portions 125 are in one piece with said grasping portions 120, i.e., with said first and second flaps 121, 122 defining the respective grasping portion 120, and are on the whole defined by a corresponding sheet, preferentially in paper material, i.e., in cardboard or paperboard 129, especially suitably shaped or die-cut, as in any case is best seen from the following of the present description.

As illustrated, in the first and second preferred embodiments 10, 100, three base portions 125, 125, 125 that are parallel to one another are provided, of which one is central and two are lateral, and four, cracks 129s, extending two by two, i.e., ten cracks, a extending five by five, between said central base portion 125 and the opposite side base portions 125, 125, and adapted to define two pairs, or two series, of three grasping portions each 120, 120, i.e., said first and second flaps 121, 122 defining the same three grasping portions 120, 120, such as to be able to grasp and hold at the ends two articles 11, 11, for the first preferred embodiment 10, or adapted to define two pairs, or two series of six grasping portions each 120, 120, 120, i.e., said first and second flaps 121, 122 defining the same six grasping portions 120, 120, such as to be able to grasp and hold at the ends five articles 11, 11, 11, 11, 11, for the second preferred embodiment 10.

In a similar manner, in the third preferred embodiment 200, five base portions 125, 125, 125, 125, 125 that are parallel to one another are provided, of which a central one, two intermediate ones, and two outermost lateral ones, and corresponding cracks extending between said central base portion 125, and the opposite intermediate portions, and between these and the opposite outermost side base portions 125, 125 and adapted to define corresponding grasping portions.

As can be seen from said figures, advantageously, said means 14 for supporting said means 12 for engaging and retaining said one or more articles 11 extend planar-like.

With advantage, as can be seen from said figures, said means 14 for supporting said means 12 for engaging and retaining said one or more articles 11 comprise a base body 149, from which said grasping portions 120, i.e., the corresponding first and second flaps 121, 122 defining the respective grasping portion 120 extend, in particular upwardly in use.

As can be seen in particular from said FIG. 3B, advantageously, said base body 149 is in the form of a corresponding sheet, preferentially in paper material, i.e., in cardboard or paperboard, and has one or more corresponding, preferably inner, crevices, or cracks, 141 for the passage of the respective grasping portion 120, i.e., for the corresponding first and second flaps 121, 122 defining the respective grasping portion 120, i.e., for the passage of corresponding series of grasping portions 120, or of corresponding series of first and second flaps 121, 122 defining the same grasping portions 120.

In an advantageous manner, as can be seen from said figures, the respective base portion 125 from which the corresponding flap 121, 122 defining the respective grasping portion 120 extends, i.e., the base portions 125 from which the corresponding flaps 121, 122 defining the respective grasping portions 120 extend, joins, or join, in an integral manner, in particular is or are glued, to said base body 149 of said supporting means 14, in particular on the side of which that is opposite the one beyond which said grasping portion 120 extends, i.e., beyond which said grasping portions 120 extend, i.e., join, or are glued, below said base body 149.

As can be seen from said figures, advantageously, said means adapted to eliminate, or reduce, the elastic return reaction of the respective folding, or creasing, line, 18, in particular said means for weakening said folding, or creasing, line, 18, especially said means 20 for interrupting the integrity of said folding, or creasing, line, 18 i.e., the corresponding cut which extends by a corresponding part of the thickness thereof, are, or is, defined, in the corresponding folding, or creasing, line, 181, 182 connecting the respective flap 121, 122 defining the respective grasping portion 120 to said means 14 for supporting said means 12 for engaging and retaining said one or more articles 11, i.e., to the corresponding base portion 125 from which the respective flap 121, 122 defining the respective grasping portion 120 extends. In particular, as illustrated a plurality of longitudinally extending cuts 20 is provided, in particular which extend across the whole length of the corresponding blank sheet, parallel to one another, especially in the number of four in said first and second preferred embodiments and in the number of eight in the third preferred embodiment.

As illustrated, a series of cuts 20, having a reduced extension within the thickness of the material, are longitudinally aligned to one another and are provided in the corresponding folding, or creasing, line, 181, 182 connecting the respective flap 121, 122 defining the respective grasping portion 120 to said means 14 for supporting said means 12 for engaging and retaining said one or more articles 11, i.e., to the corresponding base portion 125 from which the respective flap 121, 122 defining the respective grasping portion 120 extends.

In practice, as illustrated, in the first and in the second preferred embodiments, a plurality of lines of cuts 20 is provided, having a reduced extension within the thickness of the material, which are longitudinally extending and parallel to one another, and of which a cutting line 20 is continuous and extends across the whole extension of the respective small blank sheet 129, while three cutting lines consist in a respective series of cuts 20, having a reduced extension within the thickness of the material, which are longitudinally aligned to one another.

As can be seen from said figures, advantageously, said means adapted to eliminate, or reduce, the elastic return reaction of the respective folding, or creasing, line, 18′, in particular said means for weakening said folding, or creasing, line, 18′, especially said means adapted to reduce the extension, in particular the longitudinal extension, of the same folding, or creasing, line, 18′, i.e., said means for interrupting the continuity 20′ of said folding, or creasing, line, 18′, or the respective cut 20′, are, or is, defined, in the corresponding common outermost folding, or creasing, line, 180 connecting the flaps 121, 122 defining the respective grasping portion 120 to one another. In particular, as illustrated, a plurality of through cuts 20′ is provided, which are longitudinally aligned to one another on corresponding longitudinal extending lines, especially on two extending lines, in said first and second preferred embodiments and in the number of four longitudinal extending lines, in the third preferred embodiment.

As can be seen from said figures, advantageously, said base body is made, or defined, by a corresponding blank sheet 149, preferably in paper material, such as cardboard or paperboard, preferably in paper, preferentially, having a corresponding quadrangular contour, especially defined by corresponding transversal side edges 149za, 149zb connected by corresponding longitudinal side edges 149zc, 149zd, and one or more inner crevices, or cracks, 141, 141, preferably parallel to one another, and which extend prevailingly longitudinally to the same base body 149 and which are delimited, or defined, by corresponding short transversal inner edges 149ze, 149zf, in particular parallel to said transversal side edges 149za, 149zb, that connect corresponding elongated longitudinal inner edges 149zg, 149zh, in particular parallel to said longitudinal side edges 149zc, 149zd. In particular, as illustrated, the first and second preferred embodiments 10, 100 comprise a first and a second longitudinal cracks 141, 141, while the third preferred embodiment 200 comprises a first, a second, a third, and a fourth longitudinal cracks 141, 141, 141, 141.

Advantageously, in a particularly advantageous manner, as can be seen from said figures and in particular from FIG. 3A, said first and second flaps 121, 122 defining the respective grasping portion 120 and the respective base portion 125 from which these extend are obtained from a corresponding, in particular singular, shaped blank sheet 129, preferably in paper material, such as cardboard or paperboard, and preferentially having a corresponding quadrangular contour.

As can be seen from said figures and in particular from FIG. 3A, said shaped blank sheet 129, defining said means 12 for engaging and retaining said one or more articles 11, has one or more inner crevices, or cracks, 129s, especially with a prevailing transversal extension, that define, in a suitable shaped manner, the edge of corresponding first and second flaps 121, 122 defining the respective grasping portion 120.

As can be seen from said figures, advantageously, said shaped blank sheet 129, defining said means 12 for engaging and retaining said one or more articles 11, comprises a first and a second transversal side edges, preferably suitably shaped, 129ya, 129yb, in particular defining the side edge of said first and second flaps 121, 122, defining the respective grasping portion 120, and said base portions 125, from which the same flaps 121, 122 extend, and a first and a second longitudinal side edges 129yc, 129yd, in particular defining the corresponding outermost edge of respective outermost base portions 125, 125, and which connect said first and second transversal side edges 129ya, 129yb to one another.

In an appreciably advantageous manner, as can be seen from said figures, said shaped blank sheet 129, defining said means 12 for engaging and retaining said one or more articles 11, comprises, for each inner crevice or crack 129s, opposite longitudinal edges, which are possibly shaped, 129ye, 129yf and opposite transversal edges, which are preferably shaped, 129yg, 129yh, defining on the whole the corresponding inner crevice, or crack 129s, and in which each transversal edge, 129yg, 129yh is adapted to define the respective side edge of a first and of a second flaps 121, 122 defining the respective grasping portion 120.

As can be seen from said figures, advantageously, said shaped blank sheet 129, defining said means 12 for engaging and retaining said one or more articles 11, comprises a plurality of inner crevices or cracks 129s arranged on one or more longitudinal rows. In particular, as can be seen from the figures, in the first and second preferred embodiments, two parallel rows of inner cracks 129s are provided, while, in the third preferred embodiment, four parallel rows of inner cracks 129s are provided.

As can be seen from said figures, advantageously, said shaped blank sheet 129, defining said means 12 for engaging and retaining said one or more articles 11, comprises a corresponding folding, or creasing, line, 181, 182, and/or 180 between the respective base portion 125 and the corresponding flap 121, 122 defining the respective grasping portion 120, and/or between the contiguous flaps, i.e., which are one on the extension of the other one, 121, 122 and which define the respective grasping portion 120.

Advantageously, in a particularly preferred manner, it is provided for that the shaped blank sheet 129, adapted to define means 12 for engaging and retaining said one or more articles 11, and the shaped blank sheet 149, adapted to define said base body of said means 14 for supporting said means 12 for engaging and retaining said one or more articles 11, have different mechanical characteristics, i.e., preferably are in a different paper material and/or have a different basis weight, thickness and/or stiffness, preferably so that the shaped blank sheet 149, adapted to define said base body of said means 14 for supporting said means 12 for engaging and retaining said one or more articles 11, is stiffer and/or more resistant than the shaped blank sheet 129, adapted to define means 12 for engaging and retaining said one or more articles 11. In this manner, the planarity of the base is better ensured.

However, it would also be conceivable that the shaped blank sheet 129, adapted to define means 12 for engaging and retaining said one or more articles 11, and the shaped blank sheet 149, adapted to define said base body of said means 14 for supporting said means 12 for engaging and retaining said one or more articles 11, have the same mechanical characteristics, i.e., preferably are made of the same paper material and/or have the same basis weight, thickness and stiffness.

Advantageously, as can be seen from said figures, the respective blank sheet, in particular said shaped blank sheet 129, adapted to define means 12 for engaging and retaining said one or more articles 11 and/or said shaped blank sheet 149, adapted to define said base body of said means 14 for supporting said means 12 for engaging and retaining said one or more articles 11, is, or are, painted, on a respective face, i.e., on both faces, in particular by overlapping a thin layer of paint, for example waterborne or acrylic paint, preferably the lower or extrados face 129x of said shaped blank sheet 129, adapted to define means 12 for engaging and retaining said one or more articles 11 being painted.

In this manner, a better sliding ability of the support member is achieved, which is therefore such as not to cause any hindrance whatsoever to its handling, in particular within the packaging machines that use it.

Advantageously, as can be seen from said figures, means 20, 20′ which are adapted to eliminate, or reduce, the elastic return reaction of the respective folding, or creasing, line, 18, 18′, which is provided in said means 12 for engaging and retaining said one or more articles 11, are provided in said shaped blank sheet 129, which is adapted to define means 12 for engaging and retaining said one or more articles 11, in a different step and/or in the same step of the process for preparing the die-cutting or shaping of said same shaped blank sheet 129, in particular within a respective die-cutting machine; preferably said means adapted to eliminate, or reduce, the elastic return reaction of the respective folding, or creasing, line, 18, in particular said means 20 for interrupting the integrity of said folding, or creasing, line, 18, i.e., the corresponding cut which extends by a corresponding part of the thickness thereof, are, or is, obtained, in the same blank sheet 129 before the shaping or die-cutting are carried out, while said means adapted to eliminate, or reduce, the elastic return reaction of the respective folding, or creasing, line, 18′, in particular said means for interrupting the continuity 20′ of said folding, or creasing, line, 18′, or the respective cut 20′, are, or is, obtained, in the same blank sheet 129 while the shaping or die-cutting thereof are being carried out.

According to a corresponding process, the assembling of said shaped blank sheet 129, adapted to define means 12 for engaging and retaining said one or more articles 11, with said shaped blank sheet 149, adapted to define said base body of said means 14 for supporting said means 12 for engaging and retaining said one or more articles 11, can be carried out either manually or by means of a special machine or equipment.

In practice, as is clear, the technical characteristics illustrated above allow, singularly or in a respective combination, to achieve one or more of the following advantageous results:
it is possible to limit, or avoid, the deformation, or bending, of the support member of said articles, hence avoiding the presence of obstacles to the handling in the corresponding packaging machines, and in particular the insertion thereof in the corresponding, especially box-shaped, holding body;
the workmanship of the same support member is made valuable from an aesthetic viewpoint;
a corresponding folding, or creasing, line is achieved, which is sufficiently robust and capable of fulfilling its purpose, without however providing excessive and/or undesirable elastic reactions;
said support members can be made so as to be stackable;
a better sliding ability of the support member is achieved, which is therefore such as not to cause any hindrance whatsoever to its handling, in particular within the packaging machines that use it.

The present invention is susceptible of obvious industrial application.

Furthermore, those skilled in the art will be able to devise a number of modifications and/or variations to be made to the same invention, while remaining within the scope of the inventive concept, as widely explained. Furthermore, those skilled in the art will be able to devise further preferred embodiments of the invention which comprise one or more of the characteristics illustrated above of the preferred embodiment referred to above, in particular, as set forth in the attached claims. Furthermore, it shall also be understood that all the details of the invention can be replaced by technically equivalent elements.

1.-46. (canceled)

47. A member for supporting one or more articles, especially in the form of ampoules, vials or other, in particular in glass or plastic, preferably containing a product of the pharmaceutical, cosmetic and/or food type; preferentially said support member is adapted to be part of a corresponding package, especially comprising corresponding outer holding means which house, and, in particular, surround, or wrap, the same support member, and which preferably are in the form of a corresponding box-shaped body, in particular made of corresponding paper material, preferentially cardboard or paperboard, within which said support member, in particular together with said one or more articles supported thereby, is inserted; said support member comprising means for engaging and retaining said one or more articles, and means for supporting said means for engaging and retaining said one or more articles, said means for engaging and retaining said one or more articles being in corresponding foldable material, preferably in paper material, such as cardboard or paperboard, and comprising at least one corresponding folding, or creasing, line; wherein means are provided, which are adapted to eliminate, or reduce, the elastic return reaction of the respective folding, or creasing, line, which is provided in said means for engaging and retaining said one or more articles.

48. The member according to claim 47, wherein said means which are adapted to eliminate, or reduce, the elastic return reaction are provided at, in particular within, the same folding, or creasing, line.

49. The member according to claim 47, wherein said means adapted to eliminate, or reduce, the elastic return reaction of the respective folding, or creasing, line, comprise, or are in the form of corresponding means for weakening the folding, or creasing, line.

50. The member according to claim 47, wherein said means adapted to eliminate, or reduce, the elastic return reaction of the respective folding, or creasing, line, are in the form of corresponding means for interrupting the integrity of said folding, or creasing, line, in particular extending internally to said folding, or creasing, line.

51. The member according to claim 50, wherein said means for interrupting the integrity of said folding, or creasing, line, extend within the same folding, or creasing, line, only to part of the thickness of the respective folding, or creasing, line.

52. The member according to claim 51, wherein said means for interrupting the integrity of said folding, or creasing, line, comprise, or are composed of, a corresponding cut which extends at, i.e., within, the same folding, or creasing, line, by a corresponding part of the thickness thereof.

53. The member according to claim 47, wherein said means adapted to eliminate, or reduce, the elastic return reaction of the respective folding, or creasing, line, i.e., said means for weakening said folding, or creasing, line, are in the form of means adapted to reduce the extension, in particular the longitudinal extension, of the same folding, or creasing, line.

54. The member according to claim 53, wherein said means for interrupting the continuity of said folding, or creasing, line, extend passing through the same corresponding folding, or creasing, line.

55. The member according to claim 47, wherein said means adapted to eliminate, or reduce, the elastic return reaction of the respective folding, or creasing, line, are in the form of corresponding means for interrupting the continuity of said folding, or creasing, line, in particular provided internally to, or far from the ends of, said folding, or creasing, line.

56. The member according to claim 47, wherein said means adapted to eliminate, or reduce, the elastic return reaction of the respective folding, or creasing, line, comprise at least one corresponding cut, which is preferably longitudinally provided in the corresponding folding, or creasing, line.

57. The member according to claim 47, wherein said means adapted to eliminate, or reduce, the elastic return reaction of the respective folding, or creasing, line, extend across the entire length of the respective said folding, or creasing, line.

58. The member according to claim 47, wherein said means adapted to eliminate, or reduce, the elastic return reaction of the respective folding, or creasing, line, extend centrally in the corresponding folding, or creasing, line, i.e., spaced apart from the outermost edges of the same folding, or creasing, line, with said folding, or creasing, line, exhibiting at least one first and a second continuous, i.e., non-interrupted outermost parts.

59. The member according to claim 47, wherein said means adapted to eliminate, or reduce, the elastic return reaction of the respective folding, or creasing, line, comprise a single cut, preferentially a through cut, provided in said folding, or creasing, line, and which preferably extends longitudinally, in particular centrally, in the corresponding folding, or creasing, line.

60. The member according to claim 47, wherein said means adapted to eliminate, or reduce, the elastic return reaction of the respective folding, or creasing, line, i.e., the respective cut, extend, or extends, starting from the extrados face of the respective folding, or creasing, line.

61. The member according to claim 47, wherein said means for engaging and retaining said one or more articles comprise at least one first and one second grasping portions, projecting from said means for supporting the same engaging and retaining means, which are adapted to grasp, in particular by engaging it on opposite sides, a corresponding part di a respective article, or wherein said means for engaging and retaining said one or more articles comprise a plurality of series of grasping portions, in particular adapted to grasp corresponding, preferably outermost, parts, of corresponding articles, especially the respective series comprises two or more grasping portions, which are adapted to grasp corresponding parts of one or more corresponding articles.

62. The member according to claims 61, wherein the respective grasping portion for engaging and retaining the respective article comprises a respective first and second flaps projecting from said means for supporting said means for engaging and retaining said one or more articles, which said first and second flaps are preferably facing one another, and in particular spaced apart from one another, and wherein said first and second flaps defining the respective grasping portion are, in extension from said means for supporting said engaging and retaining means, convergent to one another to one another up at a common outermost folding, or creasing, line.

63. The member according to claim 47, wherein said means for engaging and retaining said one or more articles, i.e., said grasping portions, in particular the respective first and second flaps defining the respective grasping portion, extend from a corresponding base portion, in particular defining part of said means for supporting said means for engaging and retaining said one or more articles.

64. The member according to claim 47, wherein said means for supporting said means for engaging and retaining said one or more articles extend planar-like, and wherein said means for supporting said means for engaging and retaining said one or more articles comprise a base body, from which said grasping portions extend, in particular upwardly in use, i.e., the corresponding first and second flaps defining the respective grasping portion, and wherein said base body is in the form of a corresponding sheet, preferentially in paper material, i.e., in cardboard or paperboard and has one or more corresponding, preferably inner, crevices, or cracks for the passage of the respective grasping portion, i.e., for the corresponding first and second flaps defining the respective grasping portion, i.e., for the passage of corresponding series of grasping portions, or of corresponding series of first and second flaps defining the same grasping portions.

65. The member according to claim 47, wherein said means adapted to eliminate, or reduce, the elastic return reaction of the respective folding, or creasing, line, in particular said means for weakening said folding, or creasing, line, especially said means for interrupting the integrity of said folding, or creasing, line, i.e., the corresponding cut, which extends by a corresponding part of the thickness thereof, are, or is, defined, in the corresponding folding, or creasing, line, connecting the respective flap defining the respective grasping portion to said means for supporting said means for engaging and retaining said one or more articles, i.e., to the corresponding base portion from which the respective flap defining the respective grasping portion extends.

66. The member according to claim 47, wherein said means adapted to eliminate, or reduce, the elastic return reaction of the respective folding, or creasing, line, in particular said means for weakening said folding, or creasing, line, especially said means adapted to reduce the extension, in particular the longitudinal extension, of the same folding, or creasing, line, i.e., said means for interrupting the continuity of said folding, or creasing, line, or the respective cut, are, or is, defined, in the corresponding common outermost folding, or creasing, line connecting the flaps defining the respective grasping portion to one another.
